(19) United States
(12) Patent Application Publication
(10) Pub. No.: US 2021/0011843 A1
(43) Pub. Date: Jan. 14, 2021

(54) MEMORY SYSTEM AND OPERATION METHOD THEREOF

(71) Applicant: SK hynix Inc., Gyeonggi-do (KR)

(72) Inventors: Hae-Gi CHOI, Gyeonggi-do (KR); Kyeong-Rho KIM, Gyeonggi-do (KR); Dong-Hyun CHO, Gyeonggi-do (KR); Su-Chang KIM, Gyeonggi-do (KR)

(21) Appl. No.: 17/037,967

(22) Filed: Sep. 30, 2020

Related U.S. Application Data
(63) Continuation of application No. 15/817,489, filed on Nov. 20, 2017.

(30) Foreign Application Priority Data
May 24, 2017 (KR) 10-2017-0063898

(51) Int. Cl. G06F 12/02; G06F 3/06

(52) U.S. Cl. CPC G06F 12/0246; G06F 3/0688; G06F 3/065; G06F 2212/7203; G06F 3/0634; G06F 3/0619; G06F 2212/7201; G06F 3/0625

(57) ABSTRACT

A memory system may include: a memory device; and a controller. When at least one data group is received, the data group including a plurality of data which is required to be collectively processed, the controller reads preceding logical-to-physical (L2P) map information for the data group from a first table and stores the read L2P map information in a second table before reception of the plurality of the data of the data group is committed, and the controller stores the plurality of the data in the memory device, and the controller updates the L2P map information for the data group that is stored in the first table in response to the storing of the plurality of the data in the memory device.

### CROSS-REFERENCE TO RELATED APPLICATIONS

This application is a continuation of U.S. patent application Ser. No. 15/817,489 filed on Nov. 20, 2017, which claims benefits of priority of Korean Patent Application No. 10-2017-0063898 filed on May 24, 2017. The disclosure of each of the foregoing application is incorporated herein by reference in its entirety.

### BACKGROUND

### 1. Field

Exemplary embodiments of the present invention relate to a memory system and an operation method of the memory system.

### 2. Description of the Related Art

Recently, the paradigm of the computer environment is changed into a ubiquitous computing environment which allows users to get an access to a computer system anywhere anytime. For this reason, the use of portable electronic devices, such as mobile phones, digital cameras, laptop computers and the like, is surging. The portable electronic devices generally employ a memory system using a memory device for storing data. A memory system may be used as a main memory device or an auxiliary memory device of a portable electronic device.

A memory device has excellent stability and durability because it does not include a mechanical driving unit. Also, the memory device is advantageous in that it may access data quickly and consume a small amount of power. Non-limiting examples of a memory device having these advantages include a universal serial bus (USB) memory device, a memory card with diverse interfaces, and a solid state drive (SSD).

### SUMMARY

Embodiments of the present invention are directed to a memory system that recovers and manages map information on at least one data group which includes a plurality of data that are required to be collectively written, a memory controller, and a method for operating the memory system.

In accordance with an embodiment of the present invention, a memory system may include: a memory device; and a controller, wherein when at least one data group is received, the data group including a plurality of data which is required to be collectively processed, the controller reads preceding logical-to-physical (L2P) map information for the data group from a first table and stores the read L2P map information in a second table before reception of the plurality of the data of the data group is committed, and the controller stores the plurality of the data in the memory device, and the controller updates the L2P map information for the data group that is stored in the first table in response to the storing of the plurality of the data in the memory device.

The controller further may store the second table in the memory device.

The controller may further store the first table updated with the L2P map information for the data group in the memory device.

The controller may include: the first table; the second table; a buffer suitable for storing each of the plurality of the data that are received from a host; and a processor suitable for reading the preceding L2P map information from the first table and storing the read L2P map information in the second table, storing the plurality of the data in the memory device, and updating the L2P map information for the data group that is stored in the first table.

Before commit information representing a commit of the plurality of the data is received from the host, the processor may read the preceding L2P map information from the first table and store the read L2P map information in the second table, store the plurality of the data in the memory device, and update the L2P map information for the data group that is stored in the first table.

The processor may recover the L2P map information for the data group by referring to the second table in response to reception of abort information from the host.

The processor may recover the L2P map information for the data group by referring to the second table in response to occurrence of a sudden power-off (SPO).

In accordance with another embodiment of the present invention, a memory controller may include: a first table; a second table; and a processor suitable for, when at least one data group is received, the data group including a plurality of data which are required to be collectively processed, reading preceding logical-to-physical (L2P) map information for the data group from the first table and storing the read L2P map information in the second table before reception of the plurality of the data is committed, storing the plurality of the data in the memory device, and updating the L2P map information for the data group that is stored in the first table in response to the storing of the plurality of the data.

The processor may further store the second table in the memory device.

The processor may further store the first table updated with the L2P map information for the data group in the memory device.

Before commit information representing a commit of the plurality of the data is received from the host, the processor may read the preceding L2P map information from the first table and store the read L2P map information in the second table, store the plurality of the data in the memory device, and update the L2P map information for the data group that is stored in the first table.

The processor may recover the L2P map information for the data group by referring to the second table in response to reception of abort information from the host.

The processor may recover the L2P map information for the data group by referring to the second table in response to occurrence of a sudden power-off (SPO).

In accordance with yet another embodiment of the present invention, a method for operating a memory system may include: receiving at least one data group including a plurality of data which are required to be collectively processed; reading preceding logical-to-physical (L2P) map information for the data group from a first table and storing the read L2P map information in a second table before reception of the plurality of the data is committed; storing the plurality of the data in the memory device; and updating the L2P map information for the data group that is stored in the first table in response to the storing of the plurality of the data.

The method may further include: storing the second table in the memory device.

The method may further include: storing the first table updated with the L2P map information for the data group in the memory device.

The reading of the preceding logical-to-physical (L2P) map information for the data group from the first table and the storing of the read L2P map information in the second table before the reception of the plurality of the data is committed may include: reading the preceding L2P map information from the first table and storing the read L2P map information in the second table, before commit information representing a commit of the plurality of the data is received from a host.

The method may further include: recovering the L2P map information for the data group by referring to the second table in response to reception of abort information from the host.

The method may further include: recovering the L2P map information for the data group by referring to the second table in response to occurrence of a sudden power-off (SPO).

### BRIEF DESCRIPTION OF THE DRAWINGS

The above and other features and advantages of the present invention will become more apparent to those skilled in the art to which the present invention pertains by the following detailed description with reference to the attached drawings.

FIG. 1 is a block diagram illustrating a data processing system including a memory system in accordance with an embodiment of the present disclosure.

FIG. 2 is a schematic diagram illustrating an exemplary configuration of a memory device employed in the memory system shown in FIG. 1.

FIG. 3 is a circuit diagram illustrating an exemplary configuration of a memory cell array of a memory block in the memory device shown in FIG. 2.

FIG. 4 is a schematic diagram illustrating an exemplary three-dimensional structure of the memory device shown in FIG. 2.

FIG. 5 is a block diagram illustrating a memory system in accordance with an embodiment of the present disclosure.

FIG. 6 illustrates data transmission/reception between a host and a memory system in accordance with an embodiment of the present disclosure.

FIG. 7 illustrates a transaction data in accordance with an embodiment of the present disclosure.

FIG. 8 illustrates a transaction data processing in accordance with an embodiment of the present disclosure.

FIG. 9 illustrates a transaction data processing in accordance with another embodiment of the present disclosure.

FIG. 10 is a flowchart illustrating a transaction data processing flow in accordance with embodiments of the present disclosure.

FIG. 11 is a flowchart illustrating a flow of an L2P map information recovery operation for a transaction data in accordance with embodiments of the present disclosure.

FIGS. 12 to 20 are diagrams schematically illustrating application examples of the data processing system shown in FIG. 1 in accordance with various embodiments of the present disclosure.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Hereinafter, the various embodiments of the present invention will be described in detail with reference to the attached drawings.

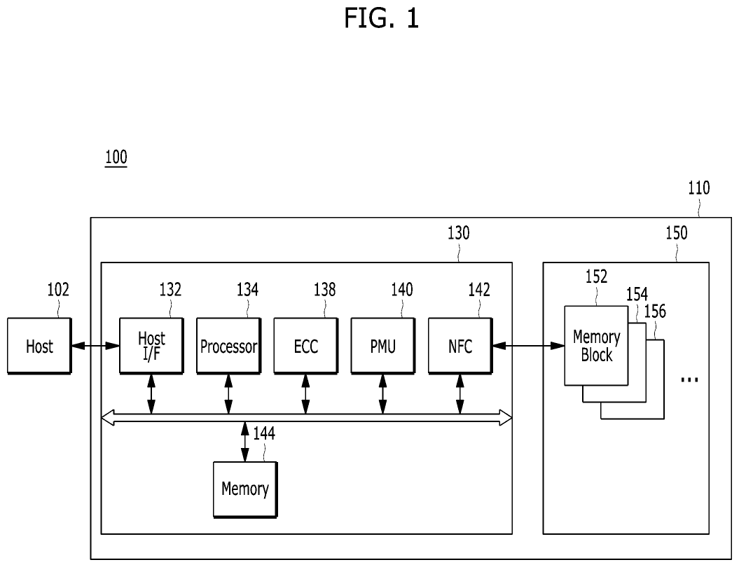

FIG. 1 is a block diagram illustrating a data processing system 100 including a memory system 110 in accordance with an embodiment of the present disclosure.

Referring to FIG. 1, the data processing system 100 may include a host 102 operatively coupled to the memory system 110.

The host 102 may be any suitable electronic device including portable electronic devices such as a mobile phone, MP3 player and laptop computer or non-portable electronic devices such as a desktop computer, game machine, television (TV) and projector. The host 102 may include at least one operating system (OS), and the OS may manage and control the overall functions and operations of the host 102, and also provide an operation between the host 102 and a user using the data processing system 100 or the memory system 110. The OS may support functions and operations corresponding to the use purpose and usage of a user. For example, the OS may be divided into a general OS and a mobile OS, depending on the mobility of the host 102. The general OS may be divided into a personal OS and an enterprise OS, depending on the environment of a user. For example, the personal OS configured to support a function of providing a service to general users may include Windows and Chrome, and the enterprise OS configured to secure and support high performance may include Windows server, Linux and Unix. Furthermore, the mobile OS configured to support a function of providing a mobile service to users and a power saving function of a system may include Android, iOS and Windows Mobile. The host 102 may include one or more of Oss. The host 102 may execute an OS to perform an operation corresponding to a user's request on the memory system 110.

The memory system 110 may operate to store data for the host 102 in response to a request of the host 102. Non-limited examples of the memory system 110 may include a solid state drive (SSD), a multi-media card (MMC), a secure digital (SD) card, universal storage bus (USB) device, a universal flash storage (UFS) device, compact flash (CF) card, a smart media card (SMC), a personal computer memory card international association (PCMCIA) card and memory stick. The MMC may include an embedded MMC (eMMC), reduced size MMC (RS-MMC) and micro-MMC. The SD card may include a mini-SD card and micro-SD card.

The memory system 110 may be embodied by various types of storage devices. Non-limited examples of storage devices included in the memory system 110 may include volatile memory devices such as a dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM) and a flash memory. The flash memory may have a 3-dimensional (3D) stack structure.

The memory system 110 may include a memory device 150 and a controller 130. The memory device 150 may store data for the host 120, and the controller 130 may control data storage into the memory device 150.

The controller 130 and the memory device 150 may be integrated into a single semiconductor device, which may be included in the various types of memory systems as exemplified above.

Non-limited application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device and may retain data stored therein even though power is not supplied. The memory device 150 may store data provided from the host 102 through a write operation, and provide data stored therein to the host 102 through a read operation. The memory device 150 may include a plurality of memory dies (not shown), each memory die including a plurality of planes (not shown), each plane including a plurality of memory blocks 152 to 156, each of the memory blocks 152 to 156 may include a plurality of pages, and each of the pages may include a plurality of memory cells coupled to a word line.

The controller 130 may control the memory device 150 in response to a request from the host 102. For example, the controller 130 may provide data read from the memory device 150 to the host 102, and store data provided from the host 102 into the memory device 150. For this operation, the controller 130 may control read, write, program and erase operations of the memory device 150.

The controller 130 may include a host interface (I/F) unit 132, a processor 134, an error correction code (ECC) unit 138, a Power Management Unit (PMU) 140, a NAND flash controller (NFC) 142 and a memory 144 all operatively coupled via an internal bus.

The host interface unit 132 may be configured to process a command and data of the host 102, and may communicate with the host 102 through one or more of various interface protocols such as universal serial bus (USB), multi-media card (MMC), peripheral component interconnect-express (PCI-e), small computer system interface (SCSI), serial-attached SCSI (SAS), serial advanced technology attachment (SATA), parallel advanced technology attachment (PATA), enhanced small disk interface (ESDI) and integrated drive electronics (IDE).

The ECC unit 138 may detect and correct an error contained in the data read from the memory device 150. In other words, the ECC unit 138 may perform an error correction decoding process to the data read from the memory device 150 through an ECC code used during an ECC encoding process. According to a result of the error correction decoding process, the ECC unit 138 may output a signal, for example, an error correction success/fail signal. When the number of error bits is more than a threshold value of correctable error bits, the ECC unit 138 may not correct the error bits, and may output an error correction fail signal.

The ECC unit 138 may perform error correction through a coded modulation such as Low Density Parity Check (LDPC) code, Bose-Chaudhri-Hocquenghem (BCH) code, turbo code, Reed-Solomon code, convolution code, Recursive Systematic Code (RSC), Trellis-Coded Modulation (TCM) and Block coded modulation (BCM). However, the ECC unit 138 is not limited thereto. The ECC unit 138 may include all circuits, modules, systems or devices for error correction.

The PMU 140 may provide and manage power of the controller 130.

The NFC 142 may serve as a memory/storage interface for interfacing the controller 130 and the memory device 150 when the memory device is a NAND flash memory, such that the controller 130 controls the memory device 150 in response to a request from the host 102. When the memory device 150 is a flash memory or specifically a NAND flash memory, the NFC 142 may generate a control signal for the memory device 150 and process data to be provided to the memory device 150 under the control of the processor 134. The NFC 142 may work as an interface (e.g., a NAND flash interface) for processing a command and data between the controller 130 and the memory device 150. Specifically, the NFC 142 may support data transfer between the controller 130 and the memory device 150. Other memory/storage interfaces may be used when a different type memory device is employed.

The memory 144 may serve as a working memory of the memory system 110 and the controller 130, and store data for driving the memory system 110 and the controller 130. The controller 130 may control the memory device 150 to perform read, write, program and erase operations in response to a request from the host 102. The controller 130 may provide data read from the memory device 150 to the host 102, may store data provided from the host 102 into the memory device 150. The memory 144 may store data required for the controller 130 and the memory device 150 to perform these operations.

The memory 144 may be embodied by a volatile memory. For example, the memory 144 may be embodied by static random access memory (SRAM) or dynamic random access memory (DRAM). The memory 144 may be disposed within or out of the controller 130. FIG. 1 exemplifies the memory 144 disposed within the controller 130. In an embodiment, the memory 144 may be embodied by an external volatile memory having a memory interface transferring data between the memory 144 and the controller 130.

The processor 134 may control the overall operations of the memory system 110. The processor 134 may drive firmware to control the overall operations of the memory system 110. The firmware may be referred to as flash translation layer (FTL).

The processor 134 of the controller 130 may include a management unit (not illustrated) for performing a bad management operation of the memory device 150. The management unit may perform a bad block management operation of checking a bad block, in which a program fail occurs due to the characteristic of a NAND flash memory during a program operation, among the plurality of memory blocks 152 to 156 included in the memory device 150. The management unit may write the program-failed data of the bad block to a new memory block. In the memory device 150 having a 3D stack structure, the bad block management operation may reduce the use efficiency of the memory device 150 and the reliability of the memory system 110. Thus, the bad block management operation needs to be performed with more reliability.

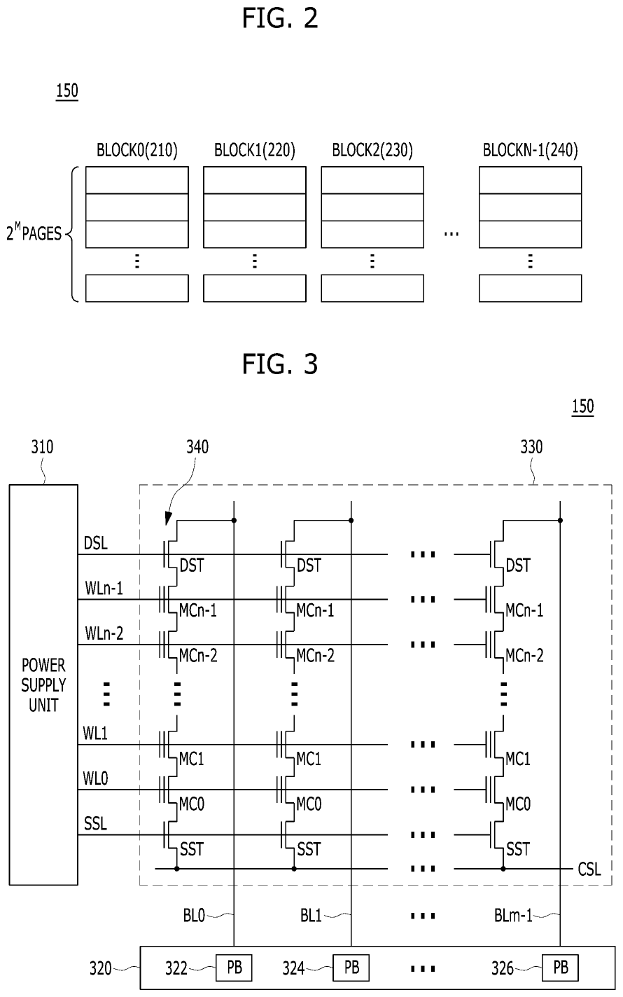

FIG. 2 is a schematic diagram illustrating an exemplary configuration of the memory device 150 employed in the memory system 110 shown in FIG. 1.

Referring to FIG. 2, the memory device 150 may include a plurality of memory blocks 0 to N−1, and each of the blocks 0 to N−1 may include a plurality of pages, for example, 2M pages, the number of which may vary according to circuit design. Memory cells included in the respective memory blocks 0 to N−1 may be one or more of a single level cell (SLC) storing 1-bit data, a multi-level cell (MLC) storing 2-bit data, an MLC storing 3-bit data also referred to as a triple level cell (TLC), an MLC storing 4-bit data also referred to as a quadruple level cell (QLC), or an MLC storing 5-bit or more bit data.

FIG. 3 is a circuit diagram illustrating an exemplary configuration of a memory cell array of a memory block in the memory device 150 shown in FIG. 2.

Referring to FIG. 3, a memory block 330 which may correspond to any of the plurality of memory blocks 152 to 156 included in the memory device 150 of the memory system 110 may include a plurality of cell strings 340 coupled to a plurality of corresponding bit lines BL0 to BLm−1. The cell string 340 of each column may include one or more drain select transistors DST and one or more source select transistors SST. Between the drain and select transistors DST and SST, a plurality of memory cells MC0 to MCn−1 may be coupled in series. In an embodiment, each of the memory cell transistors MC0 to MCn−1 may be embodied by an MLC capable of storing data information of a plurality of bits. Each of the cell strings 340 may be electrically coupled to a corresponding bit line among the plurality of bit lines BL0 to BLm−1. For example, as illustrated in FIG. 3, the first cell string is coupled to the first bit line BL0, and the last cell string is coupled to the last bit line BLm−1.

Although FIG. 3 illustrates NAND flash memory cells, the invention is not limited in this way. For example, it is noted that the memory cells may be NOR flash memory cells, or hybrid flash memory cells including two or more kinds of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply unit 310 which provides word line voltages including a program voltage, a read voltage and a pass voltage to supply to the word lines according to an operation mode. The voltage generation operation of the voltage supply unit 310 may be controlled by a control circuit (not illustrated). Under the control of the control circuit, the voltage supply unit 310 may select one of the memory blocks (or sectors) of the memory cell array, select one of the word lines of the selected memory block, and provide the word line voltages to the selected word line and the unselected word lines as may be needed.

The memory device 150 may include a read/write circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

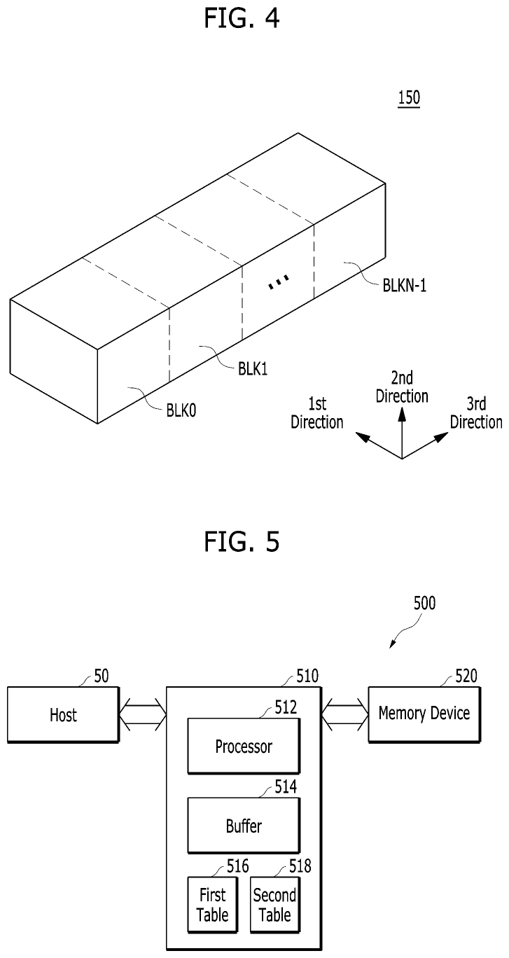

FIG. 4 is a schematic diagram illustrating an exemplary three-dimensional (3D) structure of the memory device 150 of FIG. 2.

The memory device 150 may be embodied by a two-dimensional (2D) or three-dimensional (3D) memory device. Specifically, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN−1 each having a 3D structure (or vertical structure).

As described above, the memory system may write (or program) a data (which is called a write data) that is received from the host in the memory device. For example, the write data may include a transaction data having atomicity. The transaction data may have to be one inseparable unit, just like a series of operations that have to be performed all at once in a database management system. An operation performed onto the transaction data may have to be performed for all the transaction data or canceled for all the transaction data. Therefore, the transaction data for a write operation in the memory system may mean one data group including a plurality of data that are required to be written collectively.

The following embodiments of the present disclosure may propose a method of recovering and managing map information for at least one data group each of which includes a plurality of data that are required to be written collectively. Although the transaction data before commit is written in the memory device (e.g., NAND flash memory), the transaction data may not be reflected into a translation mapping table, e.g., a logical-to-physical (L2P) map table. To remove the limitation, the embodiments of the present disclosure may reflect information into the L2P map table although a data group (or a transaction data) is not committed yet, and separately store map information that may be rolled back. The embodiments of the present disclosure may not have to perform an operation of updating the L2P map table at every commit moment, which is more likely to occur than an abort moment. Therefore, the embodiments of the present disclosure may be able to minimize map update overhead, which may occur due to the commit, by reflecting the information of the transaction data into the L2P map table, since the abort or sudden power-off (SPO) are not likely to occur in an actual memory system usage environment.

FIG. 5 is a block diagram illustrating a memory system 500 in accordance with an embodiment of the present disclosure.

Referring to FIG. 5, the memory system 500 may include a controller 510 and a memory device 520. The memory system 500, the controller 510, and the memory device 520 may correspond to the memory system 110, the controller 130, and the memory device 150 illustrated in FIG. 1, respectively, and may include the same constituent elements and perform the same operations as described above with reference to FIG. 1. Herein, it is noted that the description of the memory system 500 including the controller 510 and the memory device 520 is limited to their features and operations in accordance with embodiments of the present disclosure.

Specifically, the controller 510 includes a processor 512, a buffer 514, a first table 516, and a second table 518. In operation, the processor 512 may receive at least one data group from a host 50. In some embodiments, the at least one data group may include a plurality of data which are required to be collectively written (or programmed) in the memory device 520, as a single transaction data.

The buffer 514 may be a write cache or a write buffer for storing the at least one data group received from the host 50. The buffer 514 may be included in the inside of the memory 144 of FIG. 1 or it may be formed separately from the memory 144.

The first table 516 may be an address translation table for the data that are written in the memory device 520. For example, the first table 516 may be a logical-to-physical (L2P) map table that represents the corresponding relationship between logical addresses of the transaction data for a write operation which is received from the host 50 and physical addresses indicating storage regions of the memory device 520.

The second table 518 may be a table for reading the L2P map information for the transaction data from the first table 516 and storing the L2P map information, before one transaction data is committed. For example, the second table 518 may be a transaction recovery table for storing the L2P map information for the transaction data which is to be used for a recovery operation when a sudden power-off occurs or the transaction data is aborted before the transaction data is committed.

The processor 512 may read the preceding L2P map information for one data group from the first table 516 before the reception of a plurality of data included in the data group is committed, and store the L2P map information in the second table 518. Also, the processor 512 may store the second table 518 in the memory device 520.

The processor 512 may store the plurality of data included in the data group in the memory device 520, and update the L2P map information for the data group stored in the first table 516 when the plurality of data is stored in the memory device 520. Also, the processor 512 may store the first table 516 in which the L2P map information for the data group has been updated into the memory device 520.

According to an example, the processor 512 may be able to recover the L2P map information for the data group by referring to the second table 518, when abort information is received before the data group transferred from the host 50 is committed. According to another example, the processor 512 may be able to recover the L2P map information for the data group by referring to the second table 518, when a sudden power-off occurs before the data group transferred from the host 50 is committed.

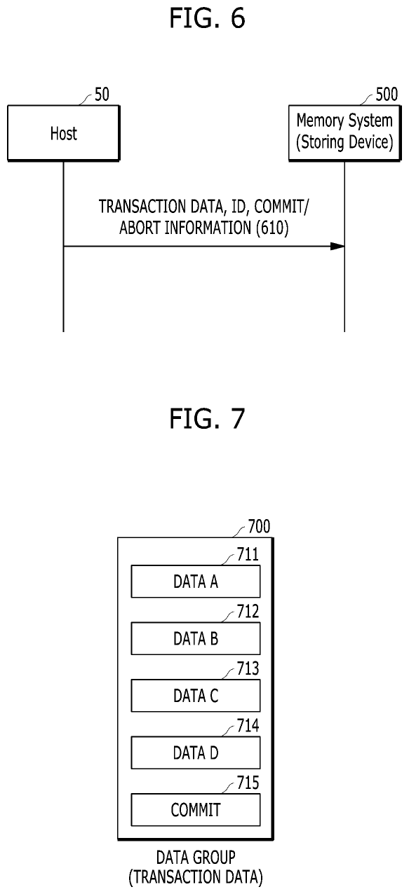

FIG. 6 illustrates data transmission/reception 610 between a host and a memory system in accordance with embodiments of the present invention. For example, the host and the memory system illustrated in FIG. 6 may be the host 50 and the memory system 500 shown in FIG. 5.

Referring to FIG. 6, the memory system 500 may receive a transaction data for a write operation from the host 50. The transaction data may mean at least one data group including a plurality of data which are required to be collectively processed. Also, the memory system 500 may receive identifier information (ID) for the transaction data for securing atomicity of the transaction data, commit information that represents the end of the transaction data, or abort information that represents a halt of the transaction data from the host 50.

FIG. 7 illustrates a transaction data 700 in accordance with an embodiment of the present disclosure. For example, the transaction data 700 may be a data for a write operation that the memory system 500 receives from the host 50.

Referring to FIG. 7, the transaction data 700 may include a data A 711, a data B 712, a data C 713, and a data D 714. The data A 711, the data B 712, the data C 713, and the data D 714 may be required to be collectively processed. In other words, the transaction data 700 may be one data group including a plurality of data which are required to be collectively processed. Also, the transaction data 700 may include commit information 715 that represents the end of the transaction data.

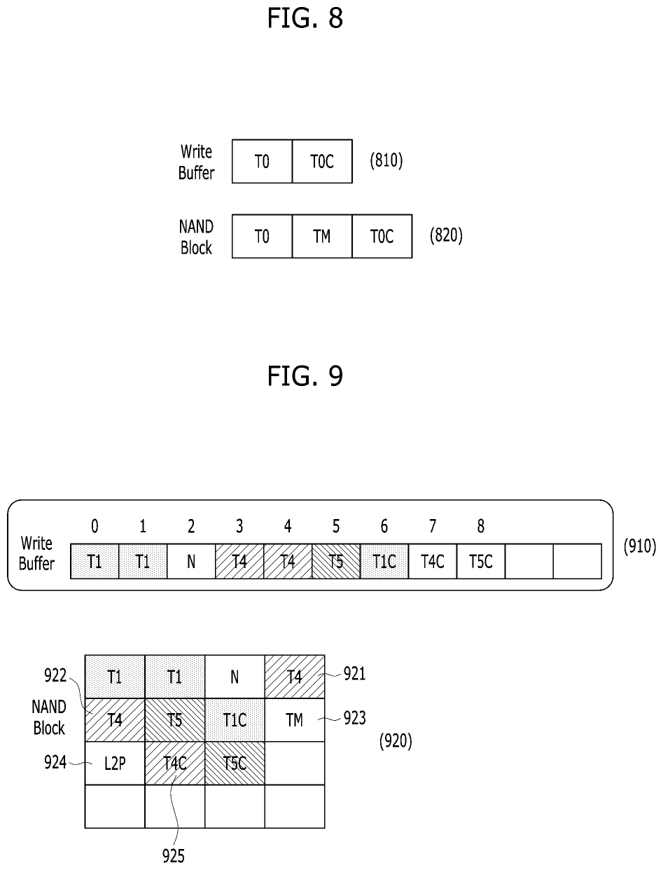

FIG. 8 illustrates a transaction data processing in accordance with an embodiment of the present disclosure. For example, the transaction data processing illustrated in FIG. 8 may be performed by the controller 510 and the memory device 520 which are described in FIG. 5. Herein, the memory device 520 may be described as a NAND flash memory, but the concept and spirit of the present disclosure are not limited to it.

Referring to FIG. 8, the controller 510 may sequentially store a received transaction data TO, commit information TOC representing the end of the transaction data in the write buffer 514 (810).

The controller 510 may store the transaction data TO stored in the write buffer 514 in a NAND block of the memory device 520. Also, although it is before the commit information TOC is received, the controller 510 may be able to generate transaction map information TM (or recovery map information) for the transaction data TO and store it in the NAND block (820).

FIG. 9 illustrates a transaction data processing in accordance with another embodiment of the present disclosure. For example, the transaction data processing illustrated in FIG. 9 may be performed by the controller 510 and the memory device 520 which are described in FIG. 5. Herein, the memory device 520 may be described as a NAND flash memory, but the concept and spirit of the present disclosure are not limited to it.

Referring to FIG. 9, the controller 510 may sequentially store received data in the write buffer 514 (910). For example, data may be stored in the write buffer 514 in the order of T1→T1→N→T4→T4→T5→T1C→T4C→T5C. Among the data that are stored in the write buffer 514, T1 may represent a first transaction data (or a data group), T4 may represent a fourth transaction data, and T5 may represent a fifth transaction data. Herein, N may represent a normal data. Also, T1C is information representing the end of the first transaction data T1, and T4C is information representing the end of the fourth transaction data T4. T5C is information representing the end of the fifth transaction data T5. Herein, a case where the transaction data commit information is received after all the transaction data are received is taken and described as an example. However, one transaction data commit information may be received right after the corresponding transaction data is received. For example, although it is described in this example that the T1C is received and stored after T5, the T1C may be received and stored after T1.

The controller 510 may store the data stored in the write buffer 514 in the NAND block. Herein, the controller 510 may generate L2P map information and transaction map information (or recovery map information) for the data and store them in the NAND block (920). Herein, an example where the L2P map information and transaction map information (or recovery map information) are generated only when the transaction data T4 is received is described but the example is not restrictive but illustrative only.

The controller 510 may store the transaction data T4 in the NAND block (921 and 922). Also, although it is before the commit information T4C for the transaction data T4 is received, the controller 510 may be able to generate L2P map information and transaction map information TM (or recovery map information) for the transaction data T4 and store them in the NAND block (923, 924 and 925).

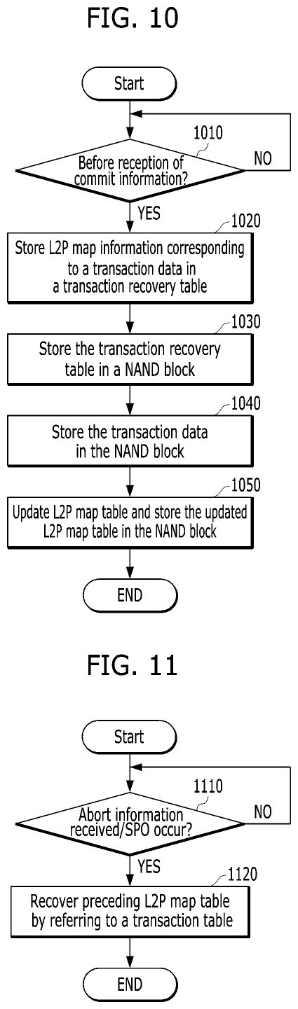

FIG. 10 is a flowchart illustrating a transaction data processing flow in accordance with an embodiment of the present disclosure. For example, the transaction data processing illustrated in FIG. 10 may be performed by the controller 510 and the memory device 520 shown in FIG. 5. Herein, it is assumed that the memory device 520 is a NAND flash memory, but the assumption is not restrictive but illustrative only. Also, for the sake of convenience in description, an example of processing a transaction data is described focusing on the operation that is performed before the commit information for one transaction data is received.

Referring to FIG. 10, in step 1010, when a transaction data is received, e.g., T4 of FIG. 9, the controller 510 may decide whether or not commit information for the transaction data has been received, e.g., T4C of FIG. 9. When the commit information for the transaction data has not been received, then the controller 510 receives the next transaction data and repeats step 1010.

When it is decided that the commit information for the transaction data has not been received as of yet, in step 1020, the controller 510 then stores the L2P map information corresponding to the transaction data in a transaction recovery table, e.g., the second table 518 of FIG. 5.

In step 1030, the controller 510 may store the transaction recovery table in the NAND block of the memory device 520. In step 1040, the controller 510 may store the transaction data in the NAND block of the memory device 520. Herein, although an example where the transaction data is stored after the transaction recovery table is stored in the memory device 520 is described, the opposite order (e.g., FIG. 9) may also employed.

In step 1050, the controller 510 may update the L2P map table (e.g., the first table 516 of FIG. 5), and store the updated L2P map table in the NAND block of the memory device 520.

FIG. 11 is a flowchart illustrating a flow of an L2P map information recovery operation for a transaction data in accordance with an embodiment of the present disclosure. For example, the process of FIG. 11 may be performed by the controller 510 and the memory device 520 shown in FIG. 5. Herein, it is assumed that the memory device 520 is a NAND flash memory, but the assumption is not restrictive but illustrative only.

Referring to FIG. 11, in step 1110, the controller 510 may decide whether abort information is received or not from the host 50, or whether a sudden power-off (SPO) occurs or not before one transaction data (or one data group) is committed, i.e., before a commit information for a transaction data is received.

When it is decided that the abort information is received from the host 50 before one transaction data (or one data group) is committed or it is decided that a sudden power-off (SPO) occurs before one transaction data (or one data group) is committed, in step 1120, the controller 510 may be able to recover the L2P map information for the transaction data stored in an L2P map table (e.g., the first table 516 of FIG. 5) by referring to the transaction recovery table (e.g., the second table 518 of FIG. 5).

As described above, the embodiments of the present disclosure propose a method of recovering and managing map information for at least one data group including a plurality of data which are required to be collectively processed in a memory system (or a storing device). Although a data group (or a transaction data) is not committed yet, the embodiments of the present disclosure may reflect information into an L2P map table and separately store the map information that may be rolled back. According to the embodiments of the present disclosure, the controller does not have to perform an operation of updating the L2P map table whenever commit, which is more likely to occur than abort, occurs. Since the probability that abort or a sudden power-off occurs is quite low in the actual memory system usage environment, map update overhead, which may be caused due to a commit, may be minimized by reflecting the information of a transaction data into the L2P map table in advance in accordance with the embodiment of the present disclosure.

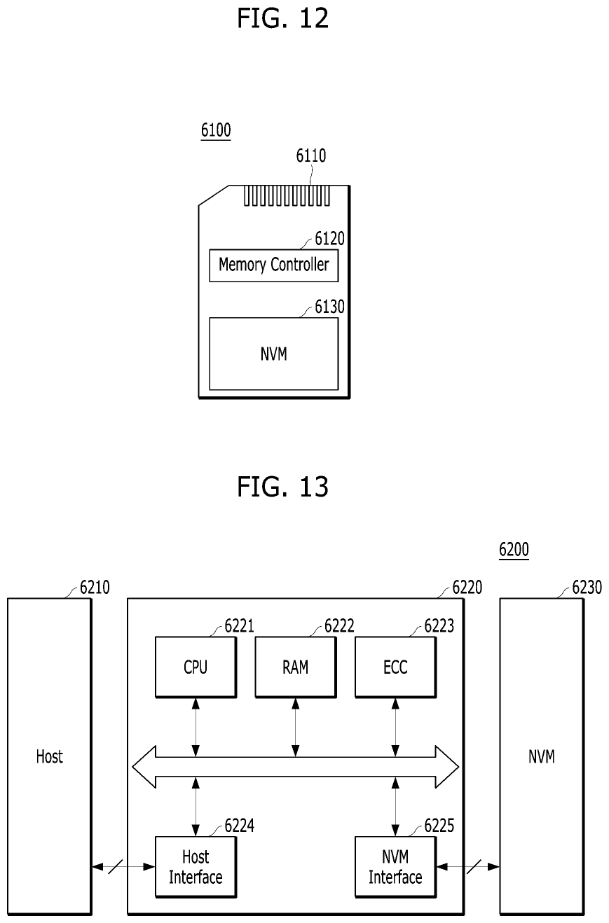

Hereinafter, a data processing system and electronic equipment provided with the memory system 110 including the memory device 150 and the controller 130 described with reference to FIGS. 1 to 11 in accordance with an embodiment will be described in more detail with reference to FIGS. 12 to 20.

FIGS. 12 to 20 are diagrams schematically illustrating application examples of the data processing system of FIG. 1 in accordance with various embodiments of the present disclosure.

FIG. 12 is a diagram schematically illustrating another example of the data processing system including the memory system in accordance with an embodiment of the present disclosure. FIG. 12 schematically illustrates a memory card system to which the memory system in accordance with an embodiment is applied.

Referring to FIG. 12, the memory card system 6100 may include a connector 6110, a memory controller 6120, and a memory device 6130.

More specifically, the memory controller 6120 may be connected to the memory device 6130 embodied by a nonvolatile memory, and configured to access the memory device 6130. For example, the memory controller 6120 may be configured to control read, write, erase and background operations of the memory device 6130. The memory controller 6120 may be configured to provide an interface between the memory device 6130 and a host, and drive firmware for controlling the memory device 6130. That is, the memory controller 6120 may correspond to the controller 130 of the memory system 110 described with reference to FIG. 1, and the memory device 6130 may correspond to the memory device 150 of the memory system 110 described with reference to FIG. 1.

Thus, the memory controller 6120 may include a random access memory (RAM), a processing unit, a host interface, a memory interface and an error correction unit. The memory controller 130 may further include the elements shown in FIG. 5.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), wireless fidelity (WI-FI) and Bluetooth. Thus, the memory system and the data processing system in accordance with an embodiment may be applied to wired/wireless electronic devices or particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM). The memory device 6130 may include a plurality of dies as in the memory device 150 of FIG. 1.

The memory controller 6120 and the memory device 6130 may be integrated into a single semiconductor device. For example, the memory controller 6120 and the memory device 6130 may construct a solid state drive (SSD) by being integrated into a single semiconductor device. Also, the memory controller 6120 and the memory device 6130 may construct a memory card such as a PC card (e.g., Personal Computer Memory Card International Association (PCMCIA)), a compact flash (CF) card, a smart media card (e.g., SM and SMC), a memory stick, a multimedia card (e.g., MMC, RS-MMC, MMCmicro and eMMC), an SD card (e.g., SD, miniSD, microSD and SDHC) and a universal flash storage (UFS).

FIG. 13 is a diagram schematically illustrating another example of the data processing system including the memory system in accordance with a present embodiment of the present disclosure.

Referring to FIG. 13, the data processing system 6200 may include a memory device 6230 having one or more nonvolatile memories (NVMs) and a memory controller 6220 for controlling the memory device 6230. The data processing system 6200 illustrated in FIG. 13 may serve as a storage medium such as a memory card (e.g., CF, SD, micro-SD or the like) or USB device, as described with reference to FIG. 1. The memory device 6230 and the memory controller 6220 may correspond to the memory device and controller described in FIGS. 1 to 10.

The memory controller 6220 may control a read, write or erase operation on the memory device 6230 in response to a request of the host 6210, and the memory controller 6220 may include a central processing unit (CPU) 6221, a random access memory (RAM) as a buffer memory 6222, an error correction code (ECC) circuit 6223, a host interface 6224 and an NVM interface as a memory interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC circuit 6223 may correspond to the ECC unit 138 of the controller 130 illustrated in FIG. 1. As described with reference to FIG. 1, the ECC circuit 6223 may generate an error correction code for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using any suitable method including a coded modulation such as a low density parity check (LDPC) code, a Bose-Chaudhuri-Hocquenghem (BCH) code, a turbo code, Reed-Solomon (RS) code, a convolution code, a recursive systematic code (RSC), a trellis-coded modulation (TCM) or a Block coded modulation (BCM).

The memory controller 6220 may transmit/receive data to/from the host 6210 through the host interface 6224, and transmit/receive data to/from the memory device 6230 through the NVM interface 6225. The host interface 6224 may be connected to the host 6210 through at least one of various interface protocols such as a parallel advanced technology attachment (PATA) bus, a serial advanced technology attachment (SATA) bus, a small computer system interface (SCSI), a universal serial bus (USB), a peripheral component interconnection express (PCIe) or a NAND interface. The memory controller 6220 may have a wireless communication function with a mobile communication protocol such as wireless fidelity (WI-FI) or long term evolution (LTE). The memory controller 6220 may be connected to an external device, for example, the host 6210 or another external device, and then transmit/receive data to/from the external device. In particular, as the memory controller 6220 is configured to communicate with the external device through one or more of various communication protocols, the memory system and the data processing system in accordance with an embodiment may be applied to wired/wireless electronic devices or particularly a mobile electronic device.

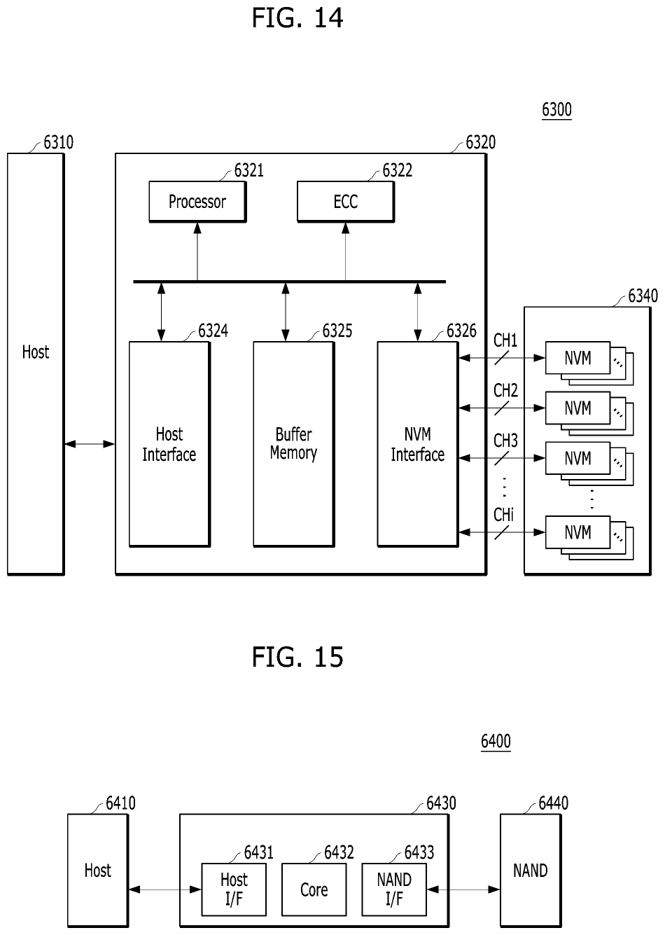

FIG. 14 is a diagram schematically illustrating another example of the data processing system including the memory system in accordance with an embodiment of the present disclosure. FIG. 14 schematically illustrates a solid state drive (SSD) 6300 to which the memory system in accordance with an embodiment is applied.

Referring to FIG. 14, the SSD 6300 may include a controller 6320 and a memory device 6340 including a plurality of nonvolatile memories. The controller 6320 and the memory device 6340 may correspond to the controller and the memory device in the memory system described with reference to FIGS. 1 to 11.

More specifically, the controller 6320 may be connected to the memory device 6340 through a plurality of channels CH1 to CHi. The controller 6320 may include a processor 6321, a buffer memory 6325, an error correction code (ECC) circuit 6322, a host interface 6324 and a nonvolatile memory interface as a memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as a dynamic random access memory (DRAM), a synchronous dynamic random access memory (SDRAM), a double data rate (DDR) SDRAM, a low power double data rate (LPDDR) SDRAM and graphic random access memory (GRAM) or nonvolatile memories such as a ferroelectric random access memory (FRAM), a resistive random access memory (ReRAM), a spin-transfer torque magnetic random access memory (STT-MRAM) and a phase change random access memory (PRAM). For convenience of description, FIG. 14 illustrates that the buffer memory 6325 exists in the controller 6320. However, the buffer memory 6325 may exist outside the controller 6320.

The ECC circuit 6322 may calculate an ECC value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, a redundant array of independent disks (RAID) system. At this time, the RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 15 is a diagram schematically illustrating another example of the data processing system including the memory system in accordance with an embodiment of the present disclosure. FIG. 15 schematically illustrates an embedded Multi-Media Card (eMMC) to which the memory system in accordance with an embodiment is applied.

Referring to FIG. 15, the eMMC 6400 may include a controller 6430 and a memory device 6440 embodied by one or more NAND flash memories. The controller 6430 may correspond to the controller in the memory system of FIGS. 1 to 11 and the memory device 6440 may correspond to the memory device in the memory system of FIGS. 1 to 11.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface such as an MMC interface as described with reference to FIG. 1. Furthermore, the host interface 6431 may serve as a serial interface such as an ultra-high speed class 1 (UHS-I)/UHS class 2 (UHS-II) and a universal flash storage (UFS) interface.

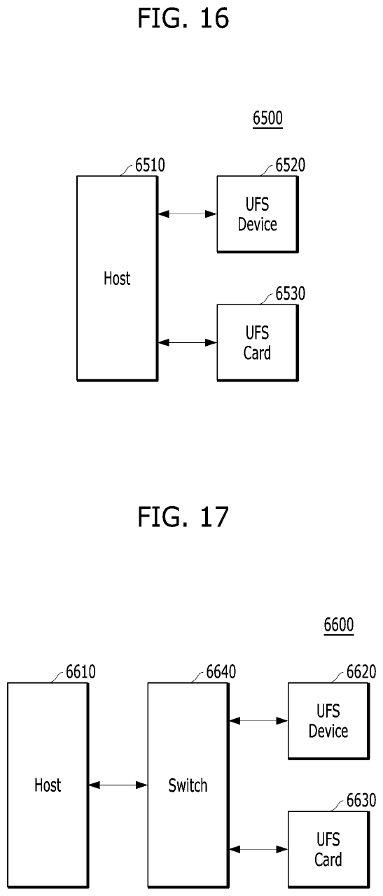

FIGS. 16 to 19 are diagrams schematically illustrating other examples of the data processing system including the memory system in accordance with embodiments of the present disclosure. FIGS. 16 to 19 schematically illustrate universal flash storage (UFS) systems to which the memory system in accordance with an embodiment is applied.

Referring to FIGS. 16 to 19, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired/wireless electronic devices or particularly mobile electronic devices, the UFS devices 6520, 6620, 6720 and 6820 may serve as embedded UFS devices, and the UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired and/or wireless electronic devices or particularly mobile electronic devices through UFS protocols, and the UFS devices 6520, 6620, 6720 and 6820 and the UFS cards 6530, 6630, 6730 and 6830 may be embodied by the memory system 110 described in reference to FIGS. 1 to 9. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 13 to 15, and the UFS cards 6530, 6630, 6730 and 6830 may be embodied in the form of the memory card system 6100 described with reference to FIG. 12.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI Unified Protocol (UniPro) in Mobile Industry Processor Interface (MIPI). Furthermore, the UFS devices 6520, 6620, 6720 and 6820 and the UFS cards 6530, 6630, 6730 and 6830 may communicate with each other through various protocols other than the UFS protocol, for example, USB flash drives (UFDs), multimedia card (MMC), secure digital (SD), mini-SD, and micro-SD.

In the UFS system 6500 illustrated in FIG. 16, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. At this time, the UFS device 6520 and the UFS card 6530 may communicate with each other through link layer switching at the UniPro of the host 6510. In an embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410, and a plurality of UFS cards may be connected in parallel or in the form of a star to the UFS device 6520 or connected in series or in the form of a chain to the UFS device 6520.

In the UFS system 6600 illustrated in FIG. 17, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In an embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

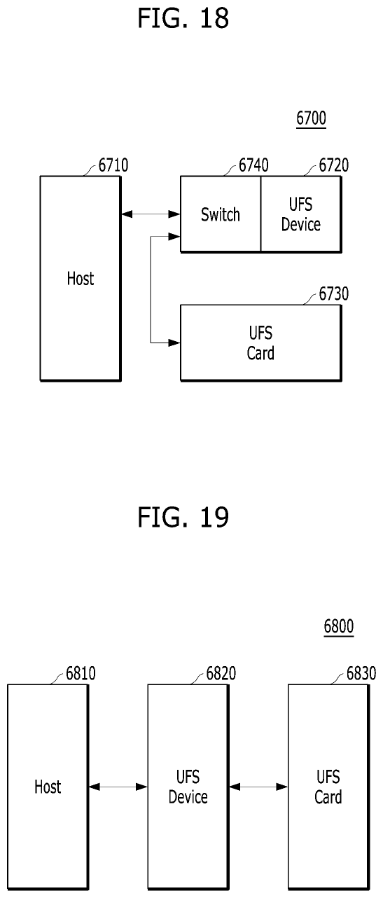

In the UFS system 6700 illustrated in FIG. 18, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. At this time, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In an embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 19, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target identifier (ID) switching operation. At this time, the host 6810 and the UFS card 6830 may communicate with each other through target ID switching between the M-PHY and UniPro modules of the UFS device 6820. In an embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

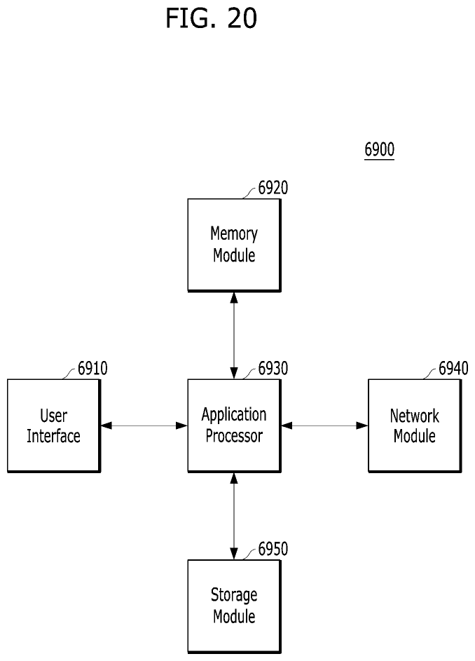

FIG. 20 is a diagram schematically illustrating another example of the data processing system including the memory system in accordance with an embodiment of the present disclosure. FIG. 20 is a diagram schematically illustrating a user system to which the memory system in accordance with an embodiment is applied.

Referring to FIG. 20, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile RAM such as a dynamic random access memory (DRAM), a synchronous dynamic random access memory (SDRAM), a double data rate (DDR) SDRAM, a DDR2 SDRAM, a DDR3 SDRAM, a low power double data rate (LPDDR) SDARM, an LPDDR2 SDRAM and an LPDDR3 SDRAM or a nonvolatile RAM such as a phase change random access memory (PRAM), a resistive random access memory (ReRAM), a magnetic random access memory (MRAM) and a ferroelectric random access memory (FRAM). For example, the application processor 6930 and the memory module 6920 may be packaged and mounted, based on a package-on-package (POP).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (WiMAX), wireless local area network (WLAN), ultra-wideband (UWB), Bluetooth, wireless display (WI-DI), thereby communicating with wired and/or wireless electronic devices or particularly mobile electronic devices. Therefore, the memory system and the data processing system, in accordance with an embodiment of the present invention, can be applied to wired and/or wireless electronic devices. The network module 6940 may be included in the application processor 6930.

The storage module 6950 may store data, for example, data provided from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 14 to 19.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, a light emitting diode (LED), a speaker and a motor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired and/or wireless communication with an external device. The user interface 6910 may display data processed by the processor 6930 on a display/touch module of the mobile electronic device, or support a function of receiving data from the touch panel.

While the present invention has been described with respect to the specific embodiments, it will be apparent to those skilled in the art that various other embodiments, changes and modifications may be made without departing from the spirit and scope of the invention as defined in the following claims.

What is claimed is:

1. A memory system, comprising:
a non-volatile memory device storing data; and
a controller coupled to the non-volatile memory device and configured to control read, program or erase operations, the controller including a first table regarding logical-to-physical (L2P) map information for the data stored in the non-volatile memory device, wherein the first table is updated when data is programmed in the non-volatile memory device,
wherein, when a data group, including plural data pieces, and commit information, indicating an end of the data group, received from a host are collectively programmed, the controller is configured to read at least one L2P map information from the first table, which corresponds to at least one of the plural data pieces in the data group, store the at least one L2P map information to a second table before the at least one of plural data pieces is programmed in the non-volatile memory device.

2. The memory system according to claim 1, wherein the controller is configured to roll back the first table based on the second table when the commit information is processed.

3. The memory system according to claim 2, wherein the commit information is processed when the plural data pieces of the data group are completely programmed in the non-volatile memory device.

4. The memory system according to claim 3, wherein the commit information is not processed when an abort information is input from the host.

5. The memory system according to claim 3, wherein the commit information is not processed when sudden power off (SPO) occurs.
